(19) United States
(12) Patent Application Publication
(10) Pub. No.: US 2005/0066349 A1
(43) Pub. Date: Mar. 24, 2005

(54) Double sided versatile disc device

(76) Inventor: Wen Chuan Liu, Taipei (TW)

Correspondence Address: Wen Chuan Liu, P. O. Box 10-69, Chong Ho, Taipei, 235, TW

(21) Appl. No.: 10/664,448

(22) Filed: Sep. 19, 2003

(51) Int. Cl. G11B 7/24; G11B 3/70; G11B 5/84; G11B 7/26

(52) U.S. Cl. 720/719; 369/286; 369/275.5

(57) ABSTRACT

A disc device includes two discs and a bonding layer applied between the discs to secure the discs together, and to allow both the discs to store information or data or signals. Each of the discs includes a protective layer engaged with the bonding layer, a reflective metalized layer for storing the information or data or signals, a dye layer applied onto the reflective metalized layer, and a basic covering layer of polycarbonate materials applied onto the dye layer for protecting the dye layer and the reflective metalized layer. The reflective metalized layer includes one or more tracks for storing the information or data or signals.

### BACKGROUND OF THE INVENTION

1. Field of the Invention

The present invention relates to a disc device, and more particularly to a double sided versatile disc device for allowing both sides of the disc device to be usable.

2. Description of the Prior Art

Various kinds of typical discs have been developed for recording radio and/or video signals therein. For example, the typical compact discs (CD), the laser discs (LD), the mini-discs (MD), etc. have been widely used to store recording radio and/or video signals and/or various computer information therein.

The other typical discs, such as the typical digital video or versatile disc (DVD) have been developed or improved from CD-ROM (read only memory), for recording radio and video signals therein.

Normally, the typical DVD has the same diameter (12 cm) and the same thickness 1.2 mm as that of the typical CD, but has a storing space or volume up to 4.7 Gb which is seven (7) times greater than that of the typical CD, such that a single DVD is good enough to store a movie for more than one hundred and thirty five (135) minutes.

However, the typical CDs, LDs, MDs, DVDs etc. include only one of two sides thereof available for recording and data storing purposes, such that the space or the volume of the memory of the typical discs may include up to 4.7 Gb only.

The present invention has arisen to mitigate and/or obviate the afore-described disadvantages of the conventional discs.

### SUMMARY OF THE INVENTION

The primary objective of the present invention is to provide a double sided versatile disc device for allowing both sides of the disc device to be usable for recording and displaying purposes, and for greatly increasing the space or the memory for recording and displaying purposes.

In accordance with one aspect of the invention, there is provided a disc device comprising a first disc, a second disc, and a bonding layer applied between the first disc and the second disc, to secure the first disc and the second disc together, and to allow both the first disc and the second disc to store information or data or signals therein.

Each of the first disc and the second disc includes a protective layer engaged with the bonding layer, and secured together with the bonding layer. Each of the first disc and the second disc includes a reflective metalized layer for storing the information or data or signals therein.

Each of the first disc and the second disc includes a dye layer applied onto the reflective metalized layer. The dye layer of each of the first disc and the second disc includes at least one track formed therein.

Each of the first disc and the second disc includes a basic covering layer applied onto the dye layer for protecting the dye layer and the reflective metalized layer. The basic covering layer of each of the first disc and the second disc is made of polycarbonate materials.

The reflective metalized layer of each of the first disc and the second disc includes at least one track formed therein for storing the information or data or signals therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a double sided versatile disc device in accordance with the present invention, taken along lines 1-1 of FIG. 2; and

FIG. 2 is a partial cross sectional view taken along lines 2-2 of FIG. 1.

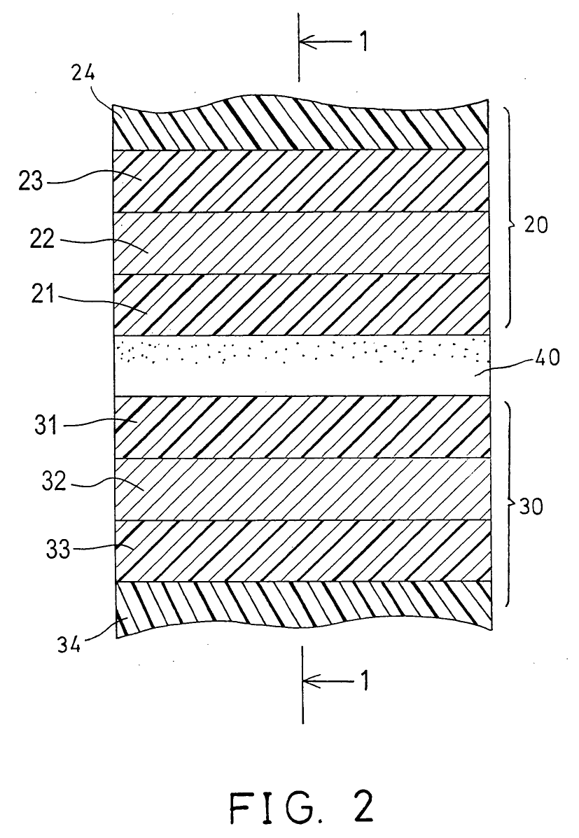

### DETAILED DESCRIPTION OF THE PREFERRED EMBODIMENT

Referring to the drawings, a double sided versatile disc device in accordance with the present invention comprises two digital video or versatile discs (DVD) 20, 30 to be coupled or secured together with a bonding layer 40 of such as hot melting glue materials, ultraviolet (UV) adhesive materials, etc.

For example, the bonding layer 40 may be applied onto either of the two DVDs 20, 30, or applied between the two DVDs 20, 30, for securing the two DVDs 20, 30 together. The two DVDs 20, 30 may either be a readable and writeable versatile discs, read only discs, or the like.

Each of the two DVDs 20, 30 includes a protective layer 21, 31 of such as protection lacquer, for being engaged with and for being secured together with the bonding layer 40, and a reflective metalized layer 22, 32 applied or provided on the outer portion of the protective layers 21, 31 respectively,

Each of the two DVDs 20, 30 further includes a dye layer 23, 33 applied or provided on the outer portion of the reflective metalized layers 22, 32 respectively, and a basic or covering layer 24, 34 made of such as polycarbonate materials, for protecting the other layers 21-23, 31-33, and for preventing the other layers 21-23, 31-33 from being scratched or damaged by other objects.

The reflective metalized layers 22, 32 are primarily provided for storing and/or recording digital signals, radio and/or video signals, and/or various computer information therein, such that the two DVDs 20, 30 may all be used to store and/or record various information therein, and such that the double sided versatile disc device in accordance with the present invention may include doubled space for information or data or signals storing and recording purposes.

The typical discs do not include two reflective metalized layers 22, 32 of two different DVDs 20, 30, for storing and/or recording digital signals, radio and/or video signals, and/or various computer information therein.

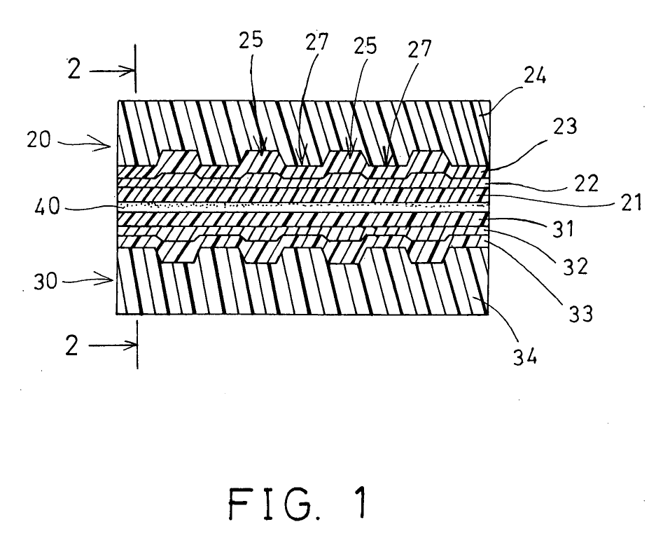

As shown in FIG. 1, it is preferable that the reflective metalized layers 22, 32, and/or the dye layers 23, 33 of the two different DVDs 20, 30, further include one or more elevated tracks or rails 25 formed or provided therein for storing and/or recording purposes, and gaps 27 formed or defined between the elevated tracks or rails 25.

Accordingly, the double sided versatile disc device in accordance with the present invention includes both sides that are usable to be recorded and displayed, for greatly increasing the space or the memory for recording and displaying purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A disc device comprising:
a first disc,
a second disc, and
a bonding layer applied between said first disc and said second disc, to secure said first disc and said second disc together, and to allow both said first disc and said second disc to store information or data or signals therein.

2. The disc device as claimed in claim 1, wherein each of said first disc and said second disc includes a protective layer engaged with said bonding layer, and secured together with said bonding layer.

3. The disc device as claimed in claim 1, wherein each of said first disc and said second disc includes a reflective metalized layer for storing the information or data or signals therein.

4. The disc device as claimed in claim 3, wherein each of said first disc and said second disc includes a dye layer applied onto said reflective metalized layer.

5. The disc device as claimed in claim 4, wherein said dye layer of each of said first disc and said second disc includes at least one track formed therein.

6. The disc device as claimed in claim 4, wherein each of said first disc and said second disc includes a basic covering layer applied onto said dye layer for protecting said dye layer and said reflective metalized layer.

7. The disc device as claimed in claim 6, wherein said basic covering layer of each of said first disc and said second disc is made of poly carbonate materials.

8. The disc device as claimed in claim 3, wherein said reflective metalized layer of each of said first disc and said second disc includes at least one track formed therein for storing the information or data or signals therein.
